(19) United States
(12) Patent Application Publication
(10) Pub. No.: US 2007/0036064 A1
(43) Pub. Date: Feb. 15, 2007

(54) Apparatus and method for estimating CINR in an OFDM communication system

(75) Inventors: Seong-Wook Song, Gwacheon-si (KR); Young-Mo Gu, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/500,957

(22) Filed: Aug. 9, 2006

(30) Foreign Application Priority Data
Aug. 9, 2005 (KR) 2005-72754
Jan. 3, 2006 (KR) 2006-570

(51) Int. Cl. H04J 11/00

(52) U.S. Cl. 370/206

(57) ABSTRACT

A method and an apparatus are provided for estimating a carrier-to-interference and noise ratio (CINR) in an orthogonal frequency division multiplexing (OFDM) communication system. The apparatus and method include a receiver for receiving a signal carried by a transmission sub-carrier including a guard band allocated to a region. Further, an estimator is provided for removing a signal component dispersed by the guard band included in a noise component of the received signal, and for estimating a CINR by calculating signal component power and interference and noise component power from the received signal from which the dispersed signal component is removed.

### CROSS-REFERENCE TO RELATED APPLICATIONS

This application claims the benefit under 35 U.S.C. § 119(a) of Korean Patent Application Serial No. 2005-72754, filed Aug. 9, 2005 in the Korean Intellectual Property Office, and of Korean Patent Application Serial No. 2006-570, filed Jan. 3, 2006 in the Korean Intellectual Property Office, the entire disclosures of both of which are hereby incorporated by reference.

### BACKGROUND OF THE INVENTION

1. Field of the Invention

The present invention relates generally to estimation of a Carrier-to-Interference and Noise Ratio (CINR) in a wireless communication system. More particularly, the present invention relates to an apparatus and method for estimating a CINR in a communication system using Orthogonal Frequency Division Multiplexing (OFDM) or Orthogonal Frequency Division Multiple Access (OFDMA) (hereinafter referred to as “OFDM/OFDMA communication system”).

2. Description of the Related Art

Wireless communication systems have been developed to transmit radio signals so as to allow terminals to perform communication regardless of their locatioon. A Code Division Multiple Access (CDMA) cellular mobile communication system is a typical wireless communication system. The CDMA cellular mobile communication system basically provides voice service and can additionally provide data service. However, with the rapid development of communication technology, data service, as compared with voice service, is increasing in importance in the CDMA cellular mobile communication system. Due to the increasing importance of the data service in the CDMA cellular mobile communication system, users and service providers desire to transmit a larger amount of data at a higher rate. However, it is considered that the CDMA cellular mobile communication system has reached its limit in providing the higher-speed data service due to the limited resources.

To address the problems caused by the limited resources of the CDMA cellular mobile communication system, there is discussion on the OFDM/OFDMA wireless communication systems, and commercialization thereof is at hand. The OFDM/OFDMA wireless communication system can transmit data at a high rate using a plurality of orthogonal frequencies. Herein, both OFDM and OFDMA, unless stated otherwise, will be commonly referred to as OFDM.

The OFDM communication system needs high-speed data transmission. For the high-speed data transmission, there is a need for high-order modulation schemes. Modulation schemes are divided into low-order modulation schemes such as Binary Phase Shift Keying (BPSK) and Quadrature Phase Shit Keying (QPSK), and high-order modulation schemes such as 16-ary Quadrature Amplitude Modulation (16QAM) and 64QAM. Performance of a transmission method based on the high-order modulation schemes greatly depends on channel conditions. That is, the transmission method can have a very high data rate in good channel conditions. However, in bad channel conditions where many retransmissions are required, the use of the high-order modulation schemes rather than the use of the low-order modulation schemes may cause deterioration of performance. Therefore, in the wireless communication system, it is important to correctly detect the channel conditions and use a modulation scheme appropriate for the detected channel conditions.

In a method for detecting the channel conditions by a transmitter of the wireless communication system, a receiver estimates a CINR for a particular signal transmitted from the transmitter and transmits the estimated CINR to the transmitter over a feedback channel, so the transmitter can detect the channel conditions. The transmitter may also determine a data rate using the information received over the feedback channel. The information received over the feedback channel has various usages. A description will now be made of a general method for estimating a CINR in the OFDM wireless communication system.

FIG. 1 is a block diagram illustrating a structure of a receiver with a CINR estimator in an OFDM system to which exemplary embodiments of the present invention can be applied.

Referring to FIG. 1, a signal received from an antenna ANT is applied to a radio frequency (RF) unit 110, and the RF unit 110 extracts a baseband analog signal from the received signal up-converted for transmission. The baseband analog signal output from the RF unit 110 is provided to an analog-to-digital converter (ADC) 120, and the ADC 120 converts the analog signal into a digital signal. The digital signal output from the ADC 120 is filtered by a filter 130 and then input to a Cyclic Prefix (CP) removing and serial-to-parallel (S/P) conversion unit 140. The CP removing and S/P conversion unit 140 removes a CP contaminated by multiple transmission paths from the output signal of the filter 130, and converts the CP-removed serial digital signal into a parallel analog signal. The parallel signal undergoes Fast Fourier Transform (FFT) in an N-point (N-pt) FFT processor 150, so the time-domain input signal is converted into a frequency-domain signal. The frequency-domain signal is input to a signal synthesizer 170.

A pseudo-random noise (PN) code generator 160 for generating a unique PN code allocated to every user generates a unique PN code allocated to each individual user, and outputs the generated PN code to the signal synthesizer 170. The signal synthesizer 170 synthesizes the PN code uniquely allocated to the corresponding user with the frequency-domain signal, so the receiver can extract only the signal transmitted thereto. The signal extracted by the signal synthesizer 170 is branched into two signals: one signal is input to a CINR estimator 180 and the other signal is input to a channel estimator 190. The CINR estimator 180 estimates a ratio of a desired signal in the received signal to an undesired interference and noise component included in the received signal. The channel estimator 190 estimates a change in channel and channel conditions.

The CINR estimated in the receiver is transmitted to a transmitter over a feedback channel. The transmitter determines a modulation order using the feedback information, modulates data in the determined modulation order, and transmits the modulated data to the receiver. Assuming that a terminal is communicating with a base station #l, a signal obtained after removing a CP symbol by the CP removing and S/P conversion unit 140 of FIG. 1 can be expressed as
y[n]=hₗ[n]Θ_{N}sₗ[n]+i[n]+w[n] (1)

In Equation (1), Θ_{N} denotes N circular convolution, hₗ[n] denotes a time-domain channel response from the base station #l to the terminal, sₗ[n] denotes a transmission signal from the base station #l, w[n] denotes an additive white Gaussian noise (AWGN), and i[n] denotes an interference signal from an adjacent cell.

A signal obtained after performing an N-pt FFT operation by the N-pt FFT processor 150 of FIG. 1 can be expressed as
y(k)=Hₗ(k)sₗ(k)+i(k)+w(k) (2)

In Equation (2), 1 denotes an index of a base station, k denotes an index of a sub-carrier, Hₗ(k) denotes an N-point Discrete Fourier Transform (DFT) value of hₗ[n] and is a frequency-domain channel response characteristic. In addition, w(k) and i(k) denote N-point DFT coefficients of time-domain AWGN noises w(n) and i(n), respectively. Herein, the sum w(k)+i(k) of interferences and noises is modeled with white noises having power

$$\frac{{I}_{l}}{N} ,$$

where Iₗ denotes power of interference signals from base stations except for the base station #l in communication with the terminal, to the terminal. In the OFDM communication system, because signal transmission is performed through N sub-carriers, power of interference signals is also carried on the N sub-carriers, achieving 1/N scaling.

The notations used herein are defined as follows. An interference signal is expressed with a subscript l because it varies according to a reference base station, and an additive noise is expressed without any subscript because it is independent of the base station. Herein, [n] and (k) are used as factors for representing a pre-FFT signal, which is a time-domain signal, and a post-FFT signal, which is a frequency-domain signal, respectively. Assuming that |sₗ(k)|²=1, a CINR between the base station #l and the terminal is defined as

$${CINR}_{l} = \frac{{\sum }_{k = 0}^{N - 1} E {\vert {H}_{l} ( k ) \vert}^{2}}{{I}_{l}} \qquad ( 3 )$$

Because |sₗ(k)|²=1, by multiplying a received signal y(k) by s*ₗ(k) in Equation (2), it is possible to obtain a signal zₗ(k) by removing the original signal sₗ(k) from Equation (2), as given below.
zₗ(k)=Hₗ(k)+iₗ(k)+wₗ(k) (4)

In Equation (4), iₗ(k) and wₗ(k) denote interference signals and additive noises, respectively, and are values given by multiplying a received signal y(k) by s*ₗ(k). In addition, because |sₗ(k)|²=1, power of

$${i}_{l} ( k ) + {w}_{l} ( k ) is \frac{{I}_{l}}{N} .$$

Generally, CINR estimation is achieved by the CINR estimator 180 of FIG. 1 in cooperation with the channel estimator 190. In brief, the CINR estimator 180 obtains an estimated channel value Ĥₗ(k) from the channel estimator 190, estimates carrier power (or signal power) using the estimated channel value Ĥₗ(k) in accordance with Equation (5) below, and estimates power of the interferences and noises using the estimated carrier power in accordance with Equation (6) below.

$$\begin{matrix}{\hat{C}}_{l} = {\sum }_{k = o}^{N - 1} {\vert {\hat{H}}_{l} ( k ) \vert}^{2} & ( 5 ) \\ {\hat{I}}_{l} = {\sum }_{k = o}^{N - 1} {\vert {z}_{l} ( k ) \vert}^{2} - {\hat{C}}_{l} & ( 6 )\end{matrix}$$

Using Equation (5) and Equation (6), the final estimated CINR can be given as

$$\hat{C} {INR}_{l} = \frac{{\hat{C}}_{l}}{{\hat{I}}_{l}} = \frac{{\sum }_{k = o}^{N - 1} {\vert {\hat{H}}_{l} ( k ) \vert}^{2}}{{\sum }_{k = o}^{N - 1} {\vert {z}_{l} ( k ) \vert}^{2} - {\sum }_{k = o}^{N - 1} {\vert {\hat{H}}_{l} ( k ) \vert}^{2}} \qquad ( 7 )$$

The method for estimating a CINR using an estimated channel value in accordance with Equation (7) greatly differs in CINR performance according to channel estimation performance. That is, accurate channel estimation increases the CINR estimation performance, but inaccurate channel estimation decreases the CINR estimation performance. Because the transmitter determines a modulation order depending on an estimated CINR fed back from the receiver, the inaccurate CINR estimation causes deterioration in the entire system performance and unnecessary repetition of retransmission. In addition, because interference and noise power is involved in the process of calculating signal power (or carrier power) in accordance with Equation (4), a bias caused by the interference and noise power may occur in the calculated signal power. That is, the interference and noise power may be included in the signal power in the calculation process, making it difficult to calculate an accurate CINR.

Accordingly, there is a need for an improved apparatus and method for estimating CINR in an OFDM communication system.

### SUMMARY OF THE INVENTION

Exemplary embodiments of the present invention address at least the above problems and/or disadvantages and provide at least the advantages described below. It is, therefore, an object of the present invention to provide an apparatus and method for accurately estimating a CINR to increase transmission efficiency by improving system performance and reducing unnecessary repetition of retransmission in an OFDM communication system.

It is another object of exemplary embodiments of the present invention to provide an apparatus and method for removing a bias occurring due to overestimation of interference and noise power in the process of receiving a signal in which a guard band is allocated to a partial region of a sub-carrier, and estimating a CINR of the received signal, in an OFDM communication system.

It is further another object of exemplary embodiments of the present invention to provide an apparatus and method for removing a bias occurring due to overestimation of interference and noise power in the process of receiving a signal in which a guard band is allocated to a partial region of a sub-carrier, and estimating a CINR of the received signal, in an OFDM communication system, and for simplifying the hardware required for implementation thereof.

According to one exemplary aspect of the present invention, there is provided an apparatus for estimating a carrier-to-interference and noise ratio (CINR) in an orthogonal frequency division multiplexing (OFDM) communication system. The apparatus comprises a receiver for receiving a signal carried by a transmission sub-carrier including a guard band allocated to a region, and an estimator for removing a signal component dispersed by the guard band included in a noise component of the received signal, and estimating a CINR by calculating signal component power and interference and noise component power from the received signal from which the dispersed signal component is removed.

In an exemplary embodiment, the estimator comprises an inverse fast Fourier transform (IFFT) processor for performing IFFT on the received signal and outputting an IFFT-processed signal, a data segmentation unit for performing data segmentation on the IFFT-processed signal in units of an interval, and outputting segmented data, a matrix inverter for performing inverse matrix calculation of a Toeplitz matrix A_{T} indicating the signal component dispersed by the guard band, on the segmented data and a calculator for calculating signal component power from the inverse matrix-calculated data, calculating interference and noise component power by subtracting the signal component power from the total received power, and estimating a CINR from the calculated signal component power and interference and noise component power.

In an exemplary embodiment, the estimator comprises an IFFT processor for performing IFFT on the received signal, and outputting an IFFT-processed signal, a data segmentation unit for performing data segmentation on the IFFT-processed signal in units of an interval, and outputting segmented data, a matrix inverter for performing inverse matrix calculation of a Toeplitz matrix A_{T} indicating the signal component dispersed by the guard band, on the segmented data and a calculator for calculating interference and noise component power by subtracting the inverse matrix-calculated data from the IFFT-processed signal, calculating signal component power by subtracting the interference and noise component power from the total received power, and estimating a CINR from the calculated signal component power and interference and noise component power.

In an exemplary embodiment, the estimator comprises an IFFT processor for performing IFFT on the received signal, and outputting an IFFT-processed signal, a data segmentation unit for performing data segmentation on the IFFT-processed signal in units of an interval, and outputting segmented data, a matrix inverter for performing inverse matrix calculation of a Toeplitz matrix A_{T} indicating the signal component dispersed by the guard band, on the segmented data and a calculator for calculating interference and noise component power from the inverse matrix-calculated data, calculating signal component power by subtracting the interference and noise component power from the total received power, and estimating a CINR from the calculated signal component power and interference and noise component power.

In an exemplary embodiment, the estimator comprises an IFFT processor for performing IFFT on the received signal, and outputting an IFFT-processed signal, a data segmentation unit for performing data segmentation on the IFFT-processed signal in units of an interval, and outputting segmented data, a fast Fourier transform (FFT) processor for performing FFT on the segmented data, and outputting FFT-processed data and a calculator for determining a pseudo inverse matrix \hat{D}⁻¹ for an approximated diagonal matrix \hat{D} having eigenvalues of a Toeplitz matrix A_{T} indicating the signal component dispersed by the guard band as elements in a noise region in the FFT-processed data, estimating power for the data having a value among the determined elements of the pseudo inverse matrix as interference and noise component power, calculating signal component power by subtracting the interference and noise component power from the total received power, and estimating a CINR from the calculated signal component power and interference and noise component power.

In an exemplary embodiment, the estimator comprises an IFFT processor for performing IFFT on the received signal, and outputting an IFFT-processed signal, a data segmentation unit for performing data segmentation on the IFFT-processed signal in units of an interval, and outputting segmented data, a FFT processor for performing FFT on the segmented data, and outputting FFT-processed data and a calculator for determining a pseudo inverse matrix \hat{D}⁻¹ for an approximated diagonal matrix \hat{D} having eigenvalues of a Toeplitz matrix A_{T} indicating the signal component dispersed by the guard band as elements in a signal region in the FFT-processed data, estimating power for the data having a value among the determined elements of the pseudo inverse matrix as signal component power, calculating interference and noise component power by subtracting the signal component power from the total received power, and estimating a CINR from the calculated signal component power and interference and noise component power.

According to another exemplary aspect of the present invention, there is provided a method for estimating a carrier-to-interference and noise ratio (CINR) in an orthogonal frequency division multiplexing (OFDM) communication system. The method comprises receiving a signal carried by a transmission sub-carrier including a guard band allocated to a region and removing a signal component dispersed by the guard band included in a noise component of the received signal, and estimating a CINR by calculating signal component power and interference and noise component power from the received signal from which the dispersed signal component is removed.

In an exemplary embodiment, estimating the CINR comprises performing inverse fast Fourier transform (IFFT) on the received signal and outputting an IFFT-processed signal, performing data segmentation on the IFFT-processed signal in units of an interval, and outputting segmented data, performing inverse matrix calculation of a Toeplitz matrix A_{T} indicating the signal component dispersed by the guard band, on the segmented data and calculating signal component power from the inverse matrix-calculated data, calculating interference and noise component power by subtracting the signal component power from the total received power, and estimating a CINR from the calculated signal component power and interference and noise component power.

In an exemplary embodiment, estimating the CINR comprises performing IFFT on the received signal, and outputting an IFFT-processed signal, performing data segmentation on the IFFT-processed signal in units of an interval, and outputting segmented data, performing inverse matrix calculation of a Toeplitz matrix A_{T} indicating the signal component dispersed by the guard band, on the segmented data and calculating interference and noise component power by subtracting the inverse matrix-calculated data from the IFFT-processed signal, calculating signal component power by subtracting the interference and noise component power from the total received power, and estimating a CINR from the calculated signal component power and interference and noise component power.

In an exemplary embodiment, estimating the CINR comprises performing IFFT on the received signal, and outputting an IFFT-processed signal, performing data segmentation on the IFFT-processed signal in units of an interval, and outputting segmented data, performing inverse matrix calculation of a Toeplitz matrix A_{T} indicating the signal component dispersed by the guard band, on the segmented data and calculating interference and noise component power from the inverse matrix-calculated data, calculating signal component power by subtracting the interference and noise component power from the total received power, and estimating a CINR from the calculated signal component power and interference and noise component power.

In an exemplary embodiment, estimating the CINR comprises performing IFFT on the received signal, and outputting an IFFT-processed signal, performing data segmentation on the IFFT-processed signal in units of an interval, and outputting segmented data, performing fast Fourier transform (FFT) on the segmented data, and outputting FFT-processed data and determining a pseudo inverse matrix \hat{D}⁻¹ for an approximated diagonal matrix \hat{D} having eigenvalues of a Toeplitz matrix A_{T} indicating the signal component dispersed by the guard band as elements in a noise region in the FFT-processed data, estimating power for the data having a value among the determined elements of the pseudo inverse matrix as interference and noise component power, calculating signal component power by subtracting the interference and noise component power from the total received power, and estimating a CINR from the calculated signal component power and interference and noise component power.

In an exemplary embodiment, estimating the CINR comprises performing IFFT on the received signal, and outputting an IFFT-processed signal, performing data segmentation on the IFFT-processed signal in units of an interval, and outputting segmented data, performing FFT on the segmented data, and outputting FFT-processed data and determining a pseudo inverse matrix \hat{D}⁻¹ for an approximated diagonal matrix \hat{D} having eigenvalues of a Toeplitz matrix A_{T} indicating the signal component dispersed by the guard band as elements in a signal region in the FFT-processed data, estimating power for the data having a value among the determined elements of the pseudo inverse matrix as signal component power, calculating interference and noise component power by subtracting the signal component power from the total received power, and estimating a CINR from the calculated signal component power and interference and noise component power.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a structure of a receiver with a CINR estimator in an OFDM system;

FIG. 2 is a diagram illustrating a signal wave obtained when IFFT is performed on the received signal in the apparatus shown in FIG. 1;

FIG. 3 is a diagram illustrating signal waves obtained when a signal with no guard band is received at the apparatus shown in FIG. 1;

FIGS. 4A and 4B are block diagrams illustrating a structure of an apparatus for estimating a CINR according to a first exemplary embodiment of the present invention;

FIG. 5 is a diagram illustrating a signal wave obtained when a signal with the guard band is transmitted;

FIG. 6 is a diagram illustrating a signal wave obtained when a signal with the guard band is received at the apparatus of FIG. 1;

FIG. 7 is a block diagram illustrating a structure of an apparatus for estimating a CINR according to a second exemplary embodiment of the present invention;

FIG. 8 is a diagram illustrating an operation of estimating a CINR according to a third exemplary embodiment of the present invention;

FIG. 9 is a block diagram illustrating a structure of an apparatus for estimating a CINR according to the third exemplary embodiment of the present invention; and

FIG. 10 is a diagram comparatively illustrating performances of CINR estimation apparatuses according to exemplary embodiments of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention will now be described in detail with reference to the annexed drawings.

A method for estimating a CINR according to an exemplary embodiment of the present invention is provided to make up for the defects of the conventional method for estimating a CINR using an estimated channel value. That is, according to the conventional CINR estimation method, as a bias is very high in a high-estimated CINR region, it is not possible to deliver an accurate CINR to a base station. Thus, the present invention proposes a bias-free CINR estimator by appropriately utilizing FFT and matrix product. In the present invention, a first exemplary embodiment provides a CINR estimation method using Inverse Fast Fourier Transform (IFFT), a second exemplary embodiment provides a CINR estimation method using IFFT and an inverse matrix, and a third exemplary embodiment provides a CINR estimation method using IFFT and FFT.

A. CINR Estimation Using IFFT (First Exemplary Embodiment)

### First Exemplary Embodiment

A time-domain signal of Equation (8) below is obtained by performing N-point Inverse Discrete Fourier Transform (IDFT), in other words, IFFT, on z₁(k) of Equation (4).
zₗ[n]=hₗ[n]+iₗ[n]+wₗ[n] (8)

Because IFFT preserves signal power, hₗ[n] is signal power, and power of iₗ[n]+wₗ[n] is interference and noise power Iₗ. In this case, using the IFFT-processed signal of Equation (8), a CINR can be calculated by

$${CINR}_{l} = \frac{{\sum }_{n = o}^{N - 1} {\vert {h}_{l} [ n ] \vert}^{2}}{{\sum }_{n = o}^{N - 1} {\vert {i}_{l} [ n ] + {w}_{l} [ n ] \vert}^{2}} \qquad ( 9 )$$

However, because the OFDM communication system is generally designed such that a channel length L is considerably less than the number N of sub-carriers (L<<N), Equation (8) can be rewritten as

$${z}_{l} [ n ] = \{ \begin{matrix}{h}_{l} [ n ] + {i}_{l} [ n ] + {w}_{l} [ n ] & for n = 0 , 1 , … , L - 1 \\ {i}_{l} [ n ] + {w}_{l} [ n ] & for n = L , L + 1 , … , N - 1\end{matrix} \qquad ( 10 )$$

In Equation (10), because a ratio of the channel length L to the number N of sub-carriers is set to a very small value of, for example, ⅛ or 1/16, the signal mainly includes a signal (or carrier) component in a region n=[0,L−1], and includes no signal component in a region n=[L,N−1].

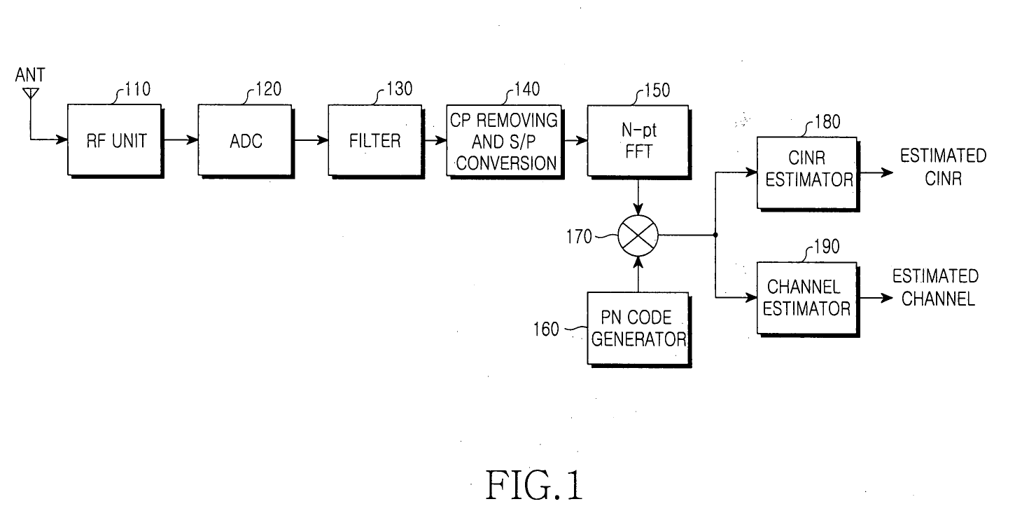

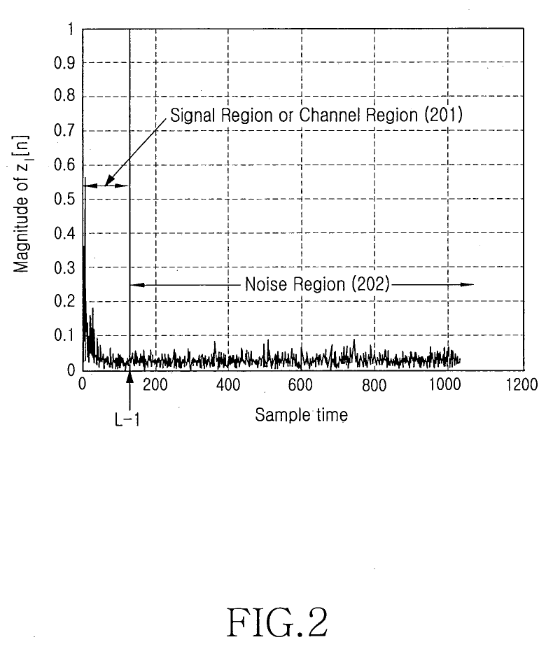

FIG. 2 is a diagram illustrating a signal wave obtained when IFFT is performed on the received signal in the apparatus shown in FIG. 1. This signal wave shows the simulation result on a signal region 201 and an interference & noise region (hereinafter simply referred to as a “noise region”) 202 when IFFT is performed the received signal for N=1024 and L=128.

As shown in FIG. 2, an IFFT-processed signal zₗ[n] is divided into a signal region 201 of [0,1, . . . ,L−1] and a noise region 202 of [L,L+1, . . . ,N−1] along the sample time axis. Therefore, only the signal in the noise region 202 can be extracted using a window for removing the signal region, and power of the noise region 202 can be calculated depending on the extracted signal.

The calculated power of the noise region 202 can be expressed as

$${\hat{I}}_{l} = {\sum }_{n = o}^{N - 1} {\vert {i}_{l} [ n ] + {w}_{l} [ n ] \vert}^{2} \approx \frac{N}{N - L} {\sum }_{n = L}^{N - 1} {\vert {z}_{l} [ n ] \vert}^{2} \qquad ( 11 )$$

Power of the signal (or carrier) can be calculated by subtracting the interference and noise power from the total received signal power in accordance with Equation (12) below.

$${\hat{C}}_{l} = {\sum }_{n = o}^{N - 1} {\vert {z}_{l} [ n ] \vert}^{2} - {\hat{I}}_{l} \qquad ( 12 )$$

From Equation (11) and Equation (12), the final estimated CINR can be calculated in accordance with Equation (13) below.

$$\hat{C} {INR}_{l} = \frac{{\hat{C}}_{l}}{{\hat{I}}_{l}} = \frac{{\sum }_{n = o}^{N - 1} {\vert {z}_{l} [ n ] \vert}^{2} - {\hat{I}}_{l}}{{\hat{I}}_{l}} \qquad ( 13 )$$

Although the method of using the signal region removing window is possible for the CINR estimation, a method of using a signal window extraction widow is also possible for the CINR estimation.

Example of a Structure According to a First Exemplary Embodiment

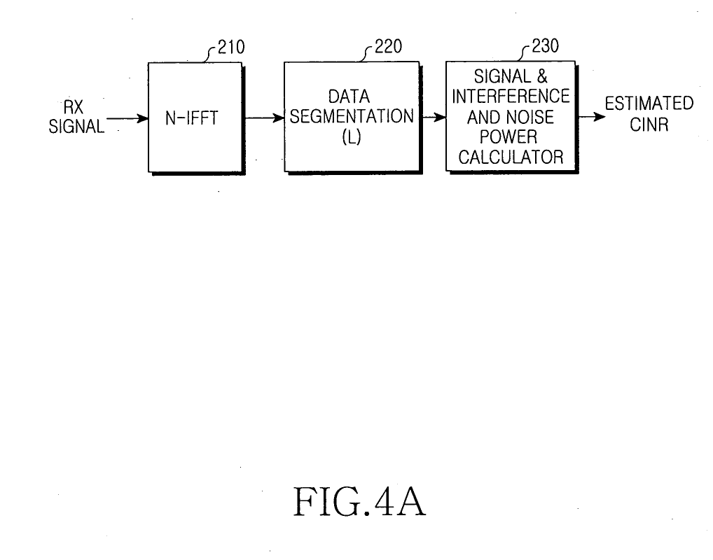

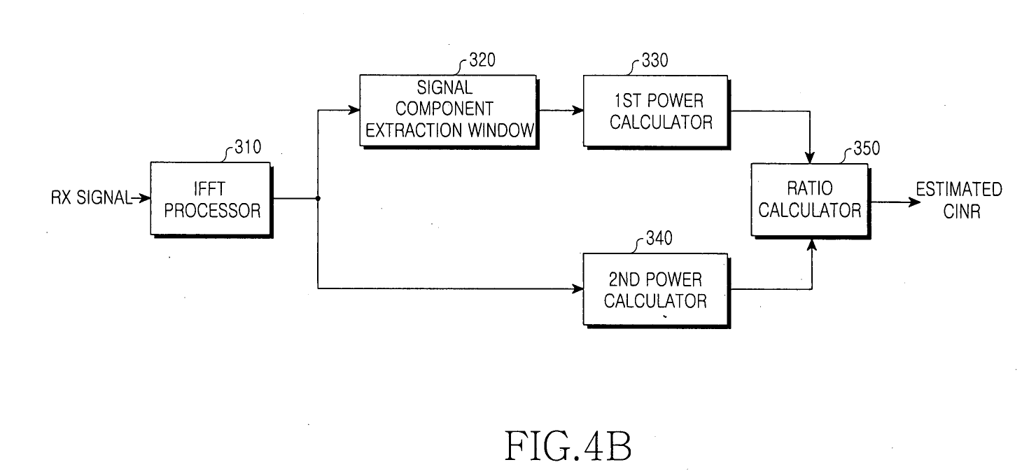

FIGS. 4A and 4B are block diagrams illustrating a structure of an apparatus for estimating a CINR according to a first exemplary embodiment of the present invention. The structure of the apparatus shown in FIG. 4B is a more detailed structure of the apparatus shown in FIG. 4A.

Referring to FIG. 4A, an exemplary CINR estimation apparatus includes an N-IFFT (or N-point IFFT) processor 210, a data segmentation unit 220, and a signal & interference and noise power calculator 230. The N-IFFT processor 210 performs IFFT on the signal output from the signal synthesizer 170 constituting the receiver of FIG. 1. The data segmentation unit 220 segments data having an appropriate length L in the signal output from the N-IFFT processor 210. The signal & interference and noise power calculator 230 calculates signal power and interference and noise power for the length-L data, calculates a CINR from the calculated power, and outputs the calculated CINR as an estimated CINR.

Referring to FIG. 4B, a received signal is the signal output from the signal synthesizer 170 constituting the receiver of FIG. 1. The signal output from the signal synthesizer 170 is input to an IFFT processor 310. The IFFT processor 310 performs IFFT on the received signal. The output signal of the IFFT processor 310 is branched into two signals: one signal is input to a signal region extraction window 320 and another signal is input to a second power calculator 340. The signal region extraction window 320 is a window used for extracting the signal region 201 of 0 to L−1, as opposed to the window described in FIG. 2. As a result, only the signal component in the signal region 201 of FIG. 2 is output by the signal region extraction window 320. The extracted signal output from the signal region extraction window 320 is input to a first power calculator 330. The first power calculator 330 calculates power of the signal output from the signal region extraction window 320, and outputs the calculated power to a ratio calculator 350.

The second power calculator 340 calculates power for the full-band received signal. That is, the second power calculator 340 calculates power of all signals existing in the signal region 201 and the noise region 202 shown in FIG. 2, and outputs the calculated power to the ratio calculator 350. The ratio calculator 350, as it has received the signal power for the signal region 201 and the signal power for the full band, can calculate a CINR in the form similar to Equation (13). The CINR calculated by the ratio calculator 350 is used as an estimated CINR.

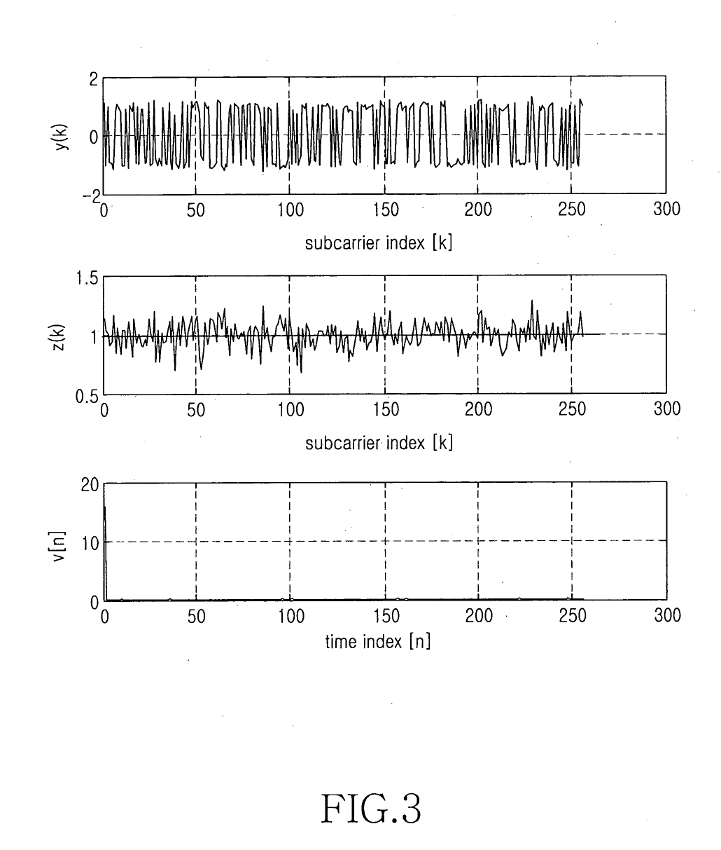

FIG. 3 is a diagram illustrating signal waves obtained when a signal with no guard band is received at the apparatus shown in FIG. 1.

FIG. 3 shows an IFFT-processed signal v[n] for a received signal y(k), and signal z(k) from which the effect of a PN code is removed, for N=256. The signal z(k) is a received signal being applied to the IFFT processor 310 of FIG. 4B, and the signal v[n] can be represented by
v[n]=h[n]+i₂[n] (14)

In Equation (14), H(k) denotes an FFT-processed value for h[n] having a length L. Because the OFDM system is generally designed such that L<<N, the channel components concentrate in the signal region as shown in FIG. 3. If the region other than the signal region is defined as an interference and noise region, interference and noise power can be estimated by extracting data from the interference and noise region and estimating power of the extracted data, and signal power can also be estimated by subtracting the estimated interference and noise power from the total received power. An exemplary apparatus for estimating the interference and noise power and the signal power, and estimating a CINR therefrom can have a structure similar to the structure shown in FIG. 4B.

B. CINR Estimation Using IFFT and Inverse Matrix (Second Exemplary Embodiment)

### Second Exemplary Embodiment

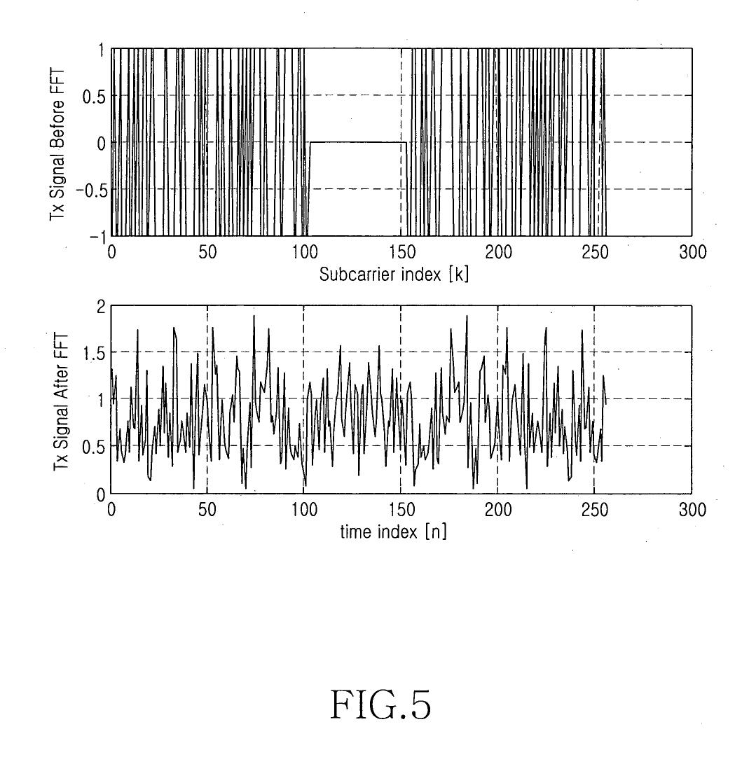

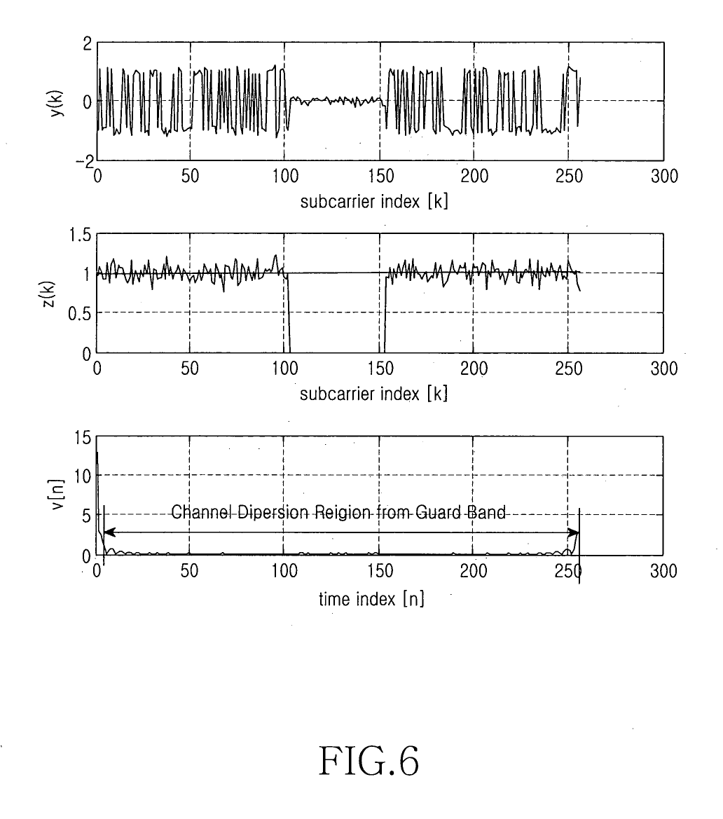

Generally, the OFDM communication system allocates a partial region in sub-carriers as a guard sub-carrier (guard band) and transmits ‘0’, taking interference from neighbor channels into consideration. A signal wave obtained when a signal with the guard band is transmitted is shown in FIG. 5, and a signal wave obtained when a signal with the guard band is received at the apparatus of FIG. 1 is shown in FIG. 6.

When the received signal with the guard band intactly undergoes IFFT in the method of the first exemplary embodiment, there is no clear difference between the signal component and the noise component as shown in FIG. 6. In addition, when noise power is measured in the method of the first exemplary embodiment, the signal component dispersed as shown in FIG. 6 is added to the original interference and noise power, resulting in overestimation of the noises. As a result, the final estimated CINR has a bias.

When the CINR estimator is implemented through an estimation theory taking a dispersion effect into account, the dispersion effect is expressed with an L×L-dimension Hermitian Toeplitz matrix A_{T}. A definition of the Toeplitz matrix will be given below. Therefore, the use of an inverse matrix A_{T}⁻¹ for the Toeplitz matrix A_{T} can remove an effect of the guard band.

Example of a Structure According to a Second Exemplary Embodiment

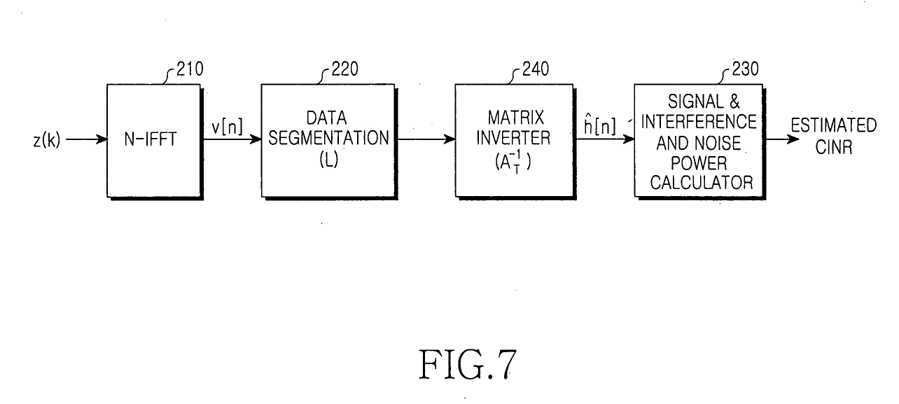

FIG. 7 is a block diagram illustrating a structure of an apparatus for estimating a CINR according to a second exemplary embodiment of the present invention.

Referring to FIG. 7, a CINR estimation apparatus includes an N-IFFT processor 210, a data segmentation unit 220, a matrix inverter 240, and a signal & interference and noise power calculator 230. This exemplary embodiment provides a CINR estimation method using IFFT and an inverse matrix. Compared with the IFFT-based method of the first exemplary embodiment, the method of the second exemplary embodiment needs a size-L² memory for storing an L×L inverse matrix and additional multiplication of L².

The N-IFFT processor 210 receives a PN code-removed signal z(k) from the receiver of FIG. 1 that receives the signal carried by transmission sub-carriers including a guard band allocated to a region, performs N-point IFFT on the received signal z(k), and outputs a signal v[n]. The data segmentation unit 220 performs data segmentation on the output signal v[n] for an appropriate length L in the signal region. The matrix inverter 240 outputs length-L data ĥ[n] using an inverse matrix A_{T}⁻¹ for the Toeplitz matrix A_{T}. The signal & interference and noise power calculator 230 calculates power of the length-L data ĥ[n], in other words calculates power of the signal component. In addition, the signal & interference and noise power calculator 230 calculates power of the interference and noise component from the calculated signal component power. The power of the interference and noise component can be obtained by subtracting the signal component power from the total received power. This power calculation operation can be achieved by providing the power calculators 330 and 340, and the ratio calculator 350 shown in FIG. 4B.

An alternative exemplary power calculation method can obtain a noise component v[n]−ĥ[n] by subtracting restored channel data ĥ[n] from IFFT-processed received signal, obtain noise component power by measuring power of the noise component signal, and estimate signal power by subtracting the noise component power from the total received power.

Anther exemplary alternative power calculation method directly measures power of the noise component. This method can take a length-L noise segment in an IFFT-processed signal, multiply the noise segment by an inverse matrix A_{T}⁻¹ of the Toeplitz matrix A_{T} to remove an effect of the guard band, and estimate noise power by calculating the result. Signal power is also obtained by subtracting the obtained noise power from the total received power. In an exemplary embodiment it is possible to take a segment where a size of the signal component is minimized, because it is necessary to minimize the effect of the signal component when taking the noise region. It can be noted from FIG. 6 that the effect of the signal component dispersed due to the guard band is minimized at the center (time index of 100 to 150) of the time domain. It is necessary to estimate noise power by taking this part.

C. CINR Estimation Using IFFT-FFT (Third Exemplary Embodiment)

### Third Exemplary Embodiment

Although the second exemplary embodiment provides an estimated CINR whose bias is removed in the full CINR region, it may require higher hardware complexity in actual implementation. A third exemplary embodiment proposes an effective CINR estimator that finds the point where a matrix A_{T} occurring due to the dispersion is expressed as an L×L-dimension Hermitian Toeplitz matrix, and uses FFT instead of an inverse matrix of the Toeplitz matrix. The Toeplitz matrix has the same diagonal matrix elements, and an example thereof is shown in Equation (15) below.

$$[ \begin{matrix}{a}_{0} & {a}_{1} & {a}_{2} \\ {a}_{- 1} & {a}_{0} & {a}_{1} \\ {a}_{- 2} & {a}_{- 1} & {a}_{0}\end{matrix} ] \qquad ( 15 )$$

The Toeplitz matrix A_{T} can be approximated as a circulant matrix A_{c}. In the circulant matrix, elements of each row are sequentially represented as cyclic shifts of the first row, and an example thereof is shown in Equation (16) below.

$$[ \begin{matrix}{a}_{0} & {a}_{1} & {a}_{1} \\ {a}_{2} & {a}_{0} & {a}_{1} \\ {a}_{1} & {a}_{1} & {a}_{0}\end{matrix} ] \qquad ( 16 )$$

The circulant matrix can undergo eigenvalue decomposition through IFFT and FFT. According to the eigenvalue decomposition theory, every matrix can be decomposed into a unitary matrix associated with a diagonal matrix. That is, every matrix can be decomposed in the form of X=USV^{H}, where U^{H}U=1, V^{H}V=1, and S denotes a diagonal matrix. For example,

$$X = [ \begin{matrix}1 & 2 \\ 2 & 1\end{matrix} ]$$

is decomposed as

$$X [ \begin{matrix}1 & 2 \\ 2 & 1\end{matrix} ] = [ \begin{matrix}- 1 / \sqrt{2} & 1 / \sqrt{2} \\ 1 / \sqrt{2} & 1 / \sqrt{2}\end{matrix} ] [ \begin{matrix}- 1 & 0 \\ 0 & 3\end{matrix} ] [ \begin{matrix}- 1 / \sqrt{2} & 1 / \sqrt{2} \\ 1 / \sqrt{2} & 1 / \sqrt{2}\end{matrix} ] \qquad ( 17 )$$

In Equation (17),

$$S = [ \begin{matrix}- 1 & 0 \\ 0 & 3\end{matrix} ] ,$$

and diagonal elements of S are called eigenvalues of the matrix X.

For the circulant matrix, it can be expressed as U=F^{H}_{L} and V^{H}=F_{L}. That is, the circulant matrix is expressed with an IFFT matrix and an FFT matrix as shown in Equation (18) below.
A_{T}≈A_{C}=F_{L}^{H}DF_{L} (18)

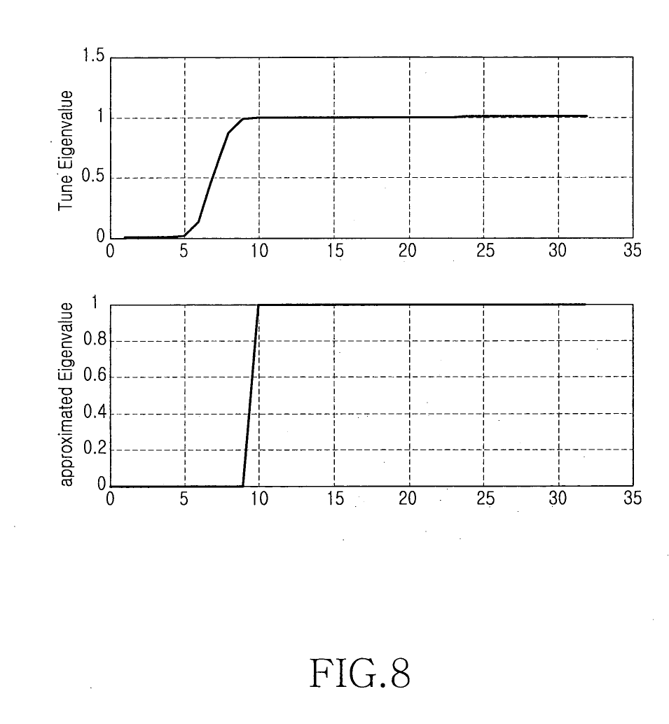

In Equation (18), F_{L} and F^{H}_{L} denote L-point FFT and L-point IFFT, respectively, and D denotes a diagonal matrix having eigenvalues of the A_{T} as elements. Eigenvalues for N=256 and L=32 are shown in FIG. 8. Therefore, an inverse matrix of the Toeplitz matrix A_{T} can be approximated as
A_{T}⁻¹≈F_{L}^{H}D⁻¹F_{L} (19)

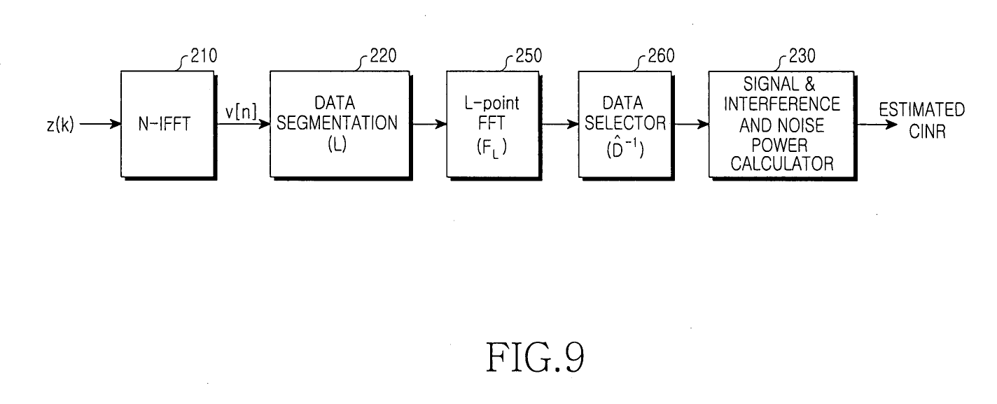

In Equation (19), the last performed operation F^{H}_{L} should not necessarily be implemented in reality, because the IFFT operation does not change the power. A CINR estimation apparatus based on the IFFT-FFT scheme can be implemented as shown in FIG. 9. It should be noted herein that although an inverse matrix of the D always exists, a variation in the eigenvalue is considerable as shown in FIG. 8, increasing numerical sensitivity of the matrix. The increase in the numeral sensitivity may cause a very large numerical error. Therefore, the diagonal matrix D also uses a matrix D where large eigenvalues are approximated to ‘1’ and small eigenvalues are approximated to ‘0’. An inverse matrix D⁻¹ of the diagonal matrix D can be replaced with a pseudo inverse matrix \hat{D}⁻¹ of the approximated matrix \hat{D}. The pseudo inverse matrix is used when there is no inverse matrix in reality. For example, the pseudo inverse matrix can be used when there is a matrix B shown in Equation (20).

$$B = [ \begin{matrix}3 & 0 & 0 \\ 0 & 2 & 0 \\ 0 & 0 & 0\end{matrix} ] \qquad ( 20 )$$

An inverse matrix B⁻¹ of the matrix B is

$${B}^{- 1} = [ \begin{matrix}1 / 3 & 0 & 0 \\ 0 & 1 / 2 & 0 \\ 0 & 0 & 1 / 0\end{matrix} ] \qquad ( 21 )$$

In Equation (21), because ‘1/0’ does not exist, the inverse matrix also does not exist. In this case, the pseudo inverse matrix calculation method calculates a pseudo inverse matrix of Equation (22) by performing division only on the non-zero values.

$${\hat{B}}^{- 1} = [ \begin{matrix}1 / 3 & 0 & 0 \\ 0 & 1 / 2 & 0 \\ 0 & 0 & 0\end{matrix} ] \qquad ( 22 )$$

As a result, an implementation formula for the third exemplary embodiment based on the IFFT-FFT scheme is \hat{D}⁻¹F_{L}. Equation (23) below shows an approximated matrix of a diagonal matrix, and Equation (24) below shows a pseudo inverse matrix of the approximated matrix.
\hat{D}=diag(0,0, . . . ,0,1,1,1, . . . ,1) (23)
\hat{D}⁻¹=diag(0,0, . . . 0,1,1,1, . . . ,1) (24)

The CINR estimation according to this exemplary embodiment is performed by the apparatus shown in FIG. 9.

Example of a Structure According to a Third Exemplary Embodiment

FIG. 9 is a block diagram illustrating a structure of an apparatus for estimating a CINR according to a third exemplary embodiment of the present invention.

Referring to FIG. 9, a CINR estimation apparatus includes an N-IFFT processor 210, a data segmentation unit 220, an L-point FFT processor 250, a data selector 260, and a signal & interference and noise power calculator 230. This exemplary embodiment replaces the matrix inverter 240 with the L-point FFT processor 250 and the data selector 260 as compared to the second exemplary embodiment.

The N-IFFT processor 210 receives a PN code-removed signal z(k) from the receiver of FIG. 1 that receives the signal carried by transmission sub-carriers including a guard band allocated to a region, performs N-point IFFT on the received signal z(k), and outputs a signal v[n]. The data segmentation unit 220 performs data segmentation on the output signal v[n] for an appropriate length L in the signal region. The L-point FFT processor 250 performs L-point FFT on the data segment output from the data segmentation unit 220, and outputs L data units. The data selector 260 receives the L data units from the L-point FFT processor 250, and outputs data where pseudo inverse matrix elements are mapped to ‘1’. The signal & interference and noise power calculator 230 obtains signal power by estimating power of the data unit where pseudo inverse matrix elements are mapped to ‘1’, among the L data units selected by the data selector 260. In addition, the signal & interference and noise power calculator 230 calculates interference and noise power from the obtained signal power, and estimates a CINR therefrom.

Generally, the power of the channel component (or signal component) is much higher than the power of the interference and noise, causing an increase in effect of an approximated error of an inverse matrix for L-point FFT. The increase in the approximated error of the inverse matrix may cause a large error in the final estimated CINR. Therefore, the CINR estimation apparatus of FIG. 9 obtains a signal v[n] by performing N-point IFFT on the PN code-removed signal z(k), performs length-L data segmentation on the signal v[n] in a noise region, and then obtains L data units by performing L-point FFT on the data segment. Thereafter, the apparatus estimates power of the data units where pseudo inverse matrix elements are mapped to ‘1’, and obtains interference and noise power. The signal & interference and noise power calculator 230 calculates signal power from the obtained interference and noise power, and estimates a CINR therefrom.

D. Simulation Result

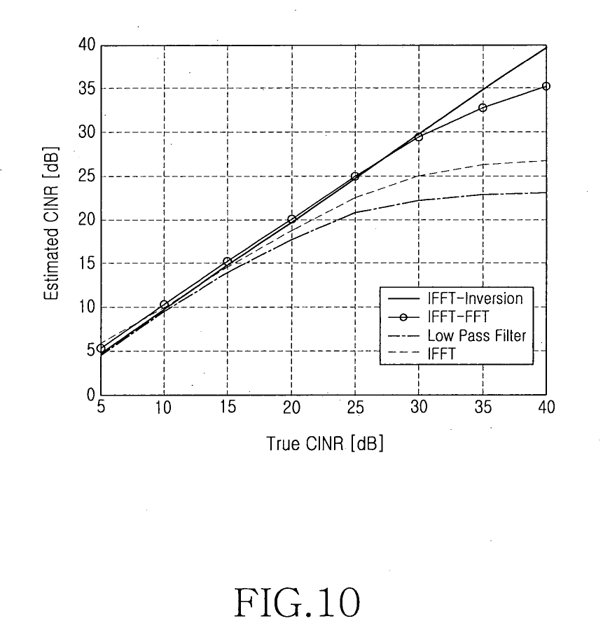

FIG. 10 is a diagram comparatively illustrating performances of CINR estimation apparatuses according to exemplary embodiments of the present invention. The drawing shows the simulation results in a channel environment similar to that of IEEE 802.16d, and the simulation conditions are as follows.

Simulation Conditions

The number of sub-carriers is N=256.

A guard band is N_{G}=51

Preamble Type: only even sub-carriers are used

The number of repeated simulations: 10,000

Channel length and data segment length: L=32

Channel characteristic: characteristic of a path having the same power

Referring to FIG. 10, while the first exemplary embodiment shows a high bias from CINR=20 dB, the second and third exemplary embodiments show a lower bias at a CINR of up to 30 dB. The second exemplary embodiment using the inverse matrix provides a bias-free estimated CINR in the full CINR region.

As can be understood from the foregoing description, the exemplary embodiments of the present invention provide an apparatus and method for accurately estimating a CINR to increase transmission efficiency and system performance by reducing unnecessary repetition of retransmission in the OFDM communication system. The proposed apparatus and method can remove the bias occurring due to overestimation of interference and noise power in the process of estimating a CINR for a received signal where a guard band is allocated to a partial region of the sub-carrier. In addition, the exemplary embodiments of the present invention contribute to a reduction in the required hardware complexity.

Exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

While the invention has been shown and described with reference to a certain exemplary embodiment thereof, it will be understood by those skilled in the art that various changes in form and details may be made therein without departing from the spirit and scope of the invention as defined by the appended claims and the full scope of equivalents thereof.

What is claimed is:

1. An apparatus for estimating a carrier-to-interference and noise ratio (CINR) in an orthogonal frequency division multiplexing (OFDM) communication system, the apparatus comprising:
a receiver for receiving a signal carried by a transmission sub-carrier including a guard band allocated to a region; and
an estimator for removing a signal component dispersed by the guard band included in a noise component of the received signal, and estimating a CINR by calculating signal component power and interference and noise component power from the received signal from which the dispersed signal component is removed.

2. The apparatus of claim 1, wherein the estimator comprises:
an inverse fast Fourier transform (IFFT) processor for performing IFFT on the received signal and outputting an IFFT-processed signal;
a data segmentation unit for performing data segmentation on the IFFT-processed signal in units of an interval, and outputting segmented data;
a matrix inverter for performing inverse matrix calculation of a Toeplitz matrix A_{T} indicating the signal component dispersed by the guard band, on the segmented data; and
a calculator for calculating signal component power from the inverse matrix-calculated data, calculating interference and noise component power by subtracting the signal component power from the total received power, and estimating a CINR from the calculated signal component power and interference and noise component power.

3. The apparatus of claim 1, wherein the estimator comprises:
an IFFT processor for performing IFFT on the received signal, and outputting an IFFT-processed signal;
a data segmentation unit for performing data segmentation on the IFFT-processed signal in units of an interval, and outputting segmented data;
a matrix inverter for performing inverse matrix calculation of a Toeplitz matrix A_{T} indicating the signal component dispersed by the guard band, on the segmented data; and
a calculator for calculating interference and noise component power by subtracting the inverse matrix-calculated data from the IFFT-processed signal, calculating signal component power by subtracting the interference and noise component power from the total received power, and estimating a CINR from the calculated signal component power and interference and noise component power.

4. The apparatus of claim 1, wherein the estimator comprises:
an IFFT processor for performing IFFT on the received signal, and outputting an IFFT-processed signal;
a data segmentation unit for performing data segmentation on the IFFT-processed signal in units of an interval, and outputting segmented data;
a matrix inverter for performing inverse matrix calculation of a Toeplitz matrix A_{T} indicating the signal component dispersed by the guard band, on the segmented data; and
a calculator for calculating interference and noise component power from the inverse matrix-calculated data, calculating signal component power by subtracting the interference and noise component power from the total received power, and estimating a CINR from the calculated signal component power and interference and noise component power.

5. The apparatus of claim 1, wherein the estimator comprises:
an IFFT processor for performing IFFT on the received signal, and outputting an IFFT-processed signal;
a data segmentation unit for performing data segmentation on the IFFT-processed signal in units of an interval, and outputting segmented data;
a fast Fourier transform (FFT) processor for performing FFT on the segmented data, and outputting FFT-processed data; and
a calculator for determining a pseudo inverse matrix \hat{D}⁻¹ for an approximated diagonal matrix \hat{D} having eigenvalues of a Toeplitz matrix A_{T} indicating the signal component dispersed by the guard band as elements in a noise region in the FFT-processed data, estimating power for the data having a value among the determined elements of the pseudo inverse matrix as interference and noise component power, calculating signal component power by subtracting the interference and noise component power from the total received power, and estimating a CINR from the calculated signal component power and interference and noise component power.

6. The apparatus of claim 1, wherein the estimator comprises:
an IFFT processor for performing IFFT on the received signal, and outputting an IFFT-processed signal;
a data segmentation unit for performing data segmentation on the IFFT-processed signal in units of an interval, and outputting segmented data;
a FFT processor for performing FFT on the segmented data, and outputting FFT-processed data; and
a calculator for determining a pseudo inverse matrix \hat{D}⁻¹ for an approximated diagonal matrix D having eigenvalues of a Toeplitz matrix A_{T} indicating the signal component dispersed by the guard band as elements in a signal region in the FFT-processed data, estimating power for the data having a value among the determined elements of the pseudo inverse matrix as signal component power, calculating interference and noise component power by subtracting the signal component power from the total received power, and estimating a CINR from the calculated signal component power and interference and noise component power.

7. A method for estimating a carrier-to-interference and noise ratio (CINR) in an orthogonal frequency division multiplexing (OFDM) communication system, the method comprising:
receiving a signal carried by a transmission sub-carrier including a guard band allocated to a region;
removing a signal component dispersed by the guard band included in a noise component of the received signal; and
estimating a CINR by calculating signal component power and interference and noise component power from the received signal from which the dispersed signal component is removed.

8. The method of claim 7, wherein the estimating of the CINR comprises:
performing inverse fast Fourier transform (IFFT) on the received signal and outputting an IFFT-processed signal;
performing data segmentation on the IFFT-processed signal in units of an interval, and outputting segmented data;
performing inverse matrix calculation of a Toeplitz matrix A_{T} indicating the signal component dispersed by the guard band, on the segmented data; and
calculating signal component power from the inverse matrix-calculated data, calculating interference and noise component power by subtracting the signal component power from the total received power, and estimating a CINR from the calculated signal component power and interference and noise component power.

9. The method of claim 7, wherein the estimating of the CINR comprises:
performing IFFT on the received signal, and outputting an IFFT-processed signal;
performing data segmentation on the IFFT-processed signal in units of an interval, and outputting segmented data;
performing inverse matrix calculation of a Toeplitz matrix A_{T} indicating the signal component dispersed by the guard band, on the segmented data; and
calculating interference and noise component power by subtracting the inverse matrix-calculated data from the IFFT-processed signal, calculating signal component power by subtracting the interference and noise component power from the total received power, and estimating a CINR from the calculated signal component power and interference and noise component power.

10. The method of claim 7, wherein the estimating of the CINR comprises:
performing IFFT on the received signal, and outputting an IFFT-processed signal;
performing data segmentation on the IFFT-processed signal in units of an interval, and outputting segmented data;
performing inverse matrix calculation of a Toeplitz matrix A_{T} indicating the signal component dispersed by the guard band, on the segmented data; and
calculating interference and noise component power from the inverse matrix-calculated data, calculating signal component power by subtracting the interference and noise component power from the total received power, and estimating a CINR from the calculated signal component power and interference and noise component power.

11. The method of claim 7, wherein the estimating of the CINR comprises:
performing IFFT on the received signal, and outputting an IFFT-processed signal;
performing data segmentation on the IFFT-processed signal in units of an interval, and outputting segmented data;
performing fast Fourier transform (FFT) on the segmented data, and outputting FFT-processed data; and
determining a pseudo inverse matrix \hat{D}⁻¹ for an approximated diagonal matrix \hat{D} having eigenvalues of a Toeplitz matrix A_{T} indicating the signal component dispersed by the guard band as elements in a noise region in the FFT-processed data, estimating power for the data having a value among the determined elements of the pseudo inverse matrix as interference and noise component power, calculating signal component power by subtracting the interference and noise component power from the total received power, and estimating a CINR from the calculated signal component power and interference and noise component power.

12. The method of claim 7, wherein the estimating of the CINR comprises:
performing IFFT on the received signal, and outputting an IFFT-processed signal;
performing data segmentation on the IFFT-processed signal in units of an interval, and outputting segmented data;
performing FFT on the segmented data, and outputting FFT-processed data; and
determining a pseudo inverse matrix \hat{D}⁻¹ for an approximated diagonal matrix \hat{D} having eigenvalues of a Toeplitz matrix A_{T} indicating the signal component dispersed by the guard band as elements in a signal region in the FFT-processed data, estimating power for the data having a value among the determined elements of the pseudo inverse matrix as signal component power, calculating interference and noise component power by subtracting the signal component power from the total received power, and estimating a CINR from the calculated signal component power and interference and noise component power.

13. A computer-readable medium having embodied thereon instructions for estimating a carrier-to-interference and noise ratio (CINR) in an orthogonal frequency division multiplexing (OFDM) communication system, the instructions comprising:
a first set of instructions for receiving a signal carried by a transmission sub-carrier including a guard band allocated to a region;
a second set of instructions for removing a signal component dispersed by the guard band included in a noise component of the received signal; and
a third set of instructions for estimating a CINR by calculating signal component power and interference and noise component power from the received signal from which the dispersed signal component is removed.

14. The computer readable medium of claim 13, wherein the third set of instructions comprises:
instructions for performing inverse fast Fourier transform (IFFT) on the received signal and outputting an IFFT-processed signal;
instructions for performing data segmentation on the IFFT-processed signal in units of an interval, and outputting segmented data;
instructions for performing inverse matrix calculation of a Toeplitz matrix A_{T} indicating the signal component dispersed by the guard band, on the segmented data; and
instructions for calculating signal component power from the inverse matrix-calculated data, calculating interference and noise component power by subtracting the signal component power from the total received power, and estimating a CINR from the calculated signal component power and interference and noise component power.

15. The computer readable medium of claim 13, wherein the third set of instructions comprises:
instructions for performing IFFT on the received signal, and outputting an IFFT-processed signal;
instructions for performing data segmentation on the IFFT-processed signal in units of an interval, and outputting segmented data;
instructions for performing inverse matrix calculation of a Toeplitz matrix A_{T} indicating the signal component dispersed by the guard band, on the segmented data; and
instructions for calculating interference and noise component power by subtracting the inverse matrix-calculated data from the IFFT-processed signal, calculating signal component power by subtracting the interference and noise component power from the total received power, and estimating a CINR from the calculated signal component power and interference and noise component power.

16. The computer readable medium of claim 13, wherein the third set of instructions comprises:
instructions for performing IFFT on the received signal, and outputting an IFFT-processed signal;
instructions for performing data segmentation on the IFFT-processed signal in units of an interval, and outputting segmented data;
instructions for performing inverse matrix calculation of a Toeplitz matrix A_{T} indicating the signal component dispersed by the guard band, on the segmented data; and
instructions for calculating interference and noise component power from the inverse matrix-calculated data, calculating signal component power by subtracting the interference and noise component power from the total received power, and estimating a CINR from the calculated signal component power and interference and noise component power.

17. The computer readable medium of claim 13, wherein the third set of instructions comprises:
instructions for performing IFFT on the received signal, and outputting an IFFT-processed signal;
instructions for performing data segmentation on the IFFT-processed signal in units of an interval, and outputting segmented data;
instructions for performing fast Fourier transform (FFT) on the segmented data, and outputting FFT-processed data; and
instructions for determining a pseudo inverse matrix \hat{D}⁻¹ for an approximated diagonal matrix \hat{D} having eigenvalues of a Toeplitz matrix A_{T} indicating the signal component dispersed by the guard band as elements in a noise region in the FFT-processed data, estimating power for the data having a value among the determined elements of the pseudo inverse matrix as interference and noise component power, calculating signal component power by subtracting the interference and noise component power from the total received power, and estimating a CINR from the calculated signal component power and interference and noise component power.

18. The computer readable medium of claim 13, wherein the third set of instructions comprises:
instructions for performing IFFT on the received signal, and outputting an IFFT-processed signal;
instructions for performing data segmentation on the IFFT-processed signal in units of an interval, and outputting segmented data;
instructions for performing FFT on the segmented data, and outputting FFT-processed data; and
instructions for determining a pseudo inverse matrix \hat{D}⁻¹ for an approximated diagonal matrix \hat{D} having eigenvalues of a Toeplitz matrix A_{T} indicating the signal component dispersed by the guard band as elements in a signal region in the FFT-processed data, estimating power for the data having a value among the determined elements of the pseudo inverse matrix as signal component power, calculating interference and noise component power by subtracting the signal component power from the total received power, and estimating a CINR from the calculated signal component power and interference and noise component power.
